(19) United States
(12) Patent Application Publication
(10) Pub. No.: US 2009/0108158 A1
(43) Pub. Date: Apr. 30, 2009

(54) Bracket and wall mount having the same

(75) Inventors: Jae-Kyung Kim, Ansan-si (KR); Seung-Bum Kim, Anyang-si (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRO-MECHANICS CO., LTD., Suwon (KR)

(21) Appl. No.: 12/081,222

(22) Filed: Apr. 11, 2008

(30) Foreign Application Priority Data
Oct. 31, 2007 (KR) 10-2007-0110559

(51) Int. Cl. F21V 21/02; A47F 5/08

(52) U.S. Cl. 248/226.11; 248/282.1

(57) ABSTRACT

A bracket and a wall mount equipped with the bracket are disclosed. The bracket may include: a securing piece, which may be coupled to the mass, and of which one end may be coupled to the wall surface; and a supporting piece, which may be coupled to the wall surface, and which may be configured to support the securing piece such that the securing piece is at an acute angle with the wall surface. The bracket is easy to install and allows levelness adjustments even after installation.

### CROSS-REFERENCE TO RELATED APPLICATIONS

This application claims the benefit of Korean Patent Application No. 10-2007-0110559 filed with the Korean Intellectual Property Office on Oct. 31, 2007, the disclosure of which is incorporated herein by reference in its entirety.

### BACKGROUND

1. Technical Field

The present invention relates to a bracket, and to a wall mount equipped with the bracket.

2. Description of the Related Art

Displays such as TV sets and monitors that employ LCD, PDP, LED technology, etc., provide the benefit of allowing efficient use of small spaces, and are fast replacing Braun tube TV's and monitors. The increase in demand for such flat panel displays is expected to continue into the future. However, due to the thin thicknesses of these flat panel displays, it is difficult to have a flat panel display stand by itself, and thus brackets and wall mounts are being developed which allow a flat panel display to be secured onto a wall surface.

When securing a display onto a wall surface, the state of the wall surface may vary for each situation, and in some cases, the wall may not be completely vertical, so that problems may occur in which the display may droop forward. Also, with the recent trends towards larger-size displays, the weight of the display is increasing. As such, when a display is secured to a wall surface for an extended period of time, the display can become unlevel. An attempt to adjust the levelness may entail the difficulty of having to reinstall the wall mount.

The bracket on a current wall mount may be integrated with the display device, so that much time and effort may be required in installing the wall mount onto a wall surface.

### SUMMARY

An aspect of the invention provides a bracket and a wall mount having the bracket, which are easy to install, and which allow levelness adjustments after installation.

Another aspect of the invention provides a bracket for securing a mass to a wall surface. The bracket includes: a securing piece, which is coupled to the mass, and of which one end is coupled to the wall surface; and a supporting piece, which is coupled to the wall surface, and which is configured to support the securing piece such that the securing piece is at an acute angle with the wall surface.

Here, the supporting piece may support the other end of the securing piece such that the other end of the securing piece is separated from the wall surface. A protrusion portion may be formed at the other end of the securing piece, where the supporting piece can be configured to support the securing piece by having the protrusion portion inserted into a holding indentation. A levelness adjustment screw may be coupled onto either side of the supporting piece, and the levelness adjustment screws may support the other end of the securing piece at either side.

Yet another aspect of the invention provides- a wall mount for rotatably securing a mass to a wall surface. The wall mount includes: a coupling piece, coupled to the mass; a link portion, one end of which is coupled to the coupling piece; and a bracket coupled to the other end of the link portion and coupled to the wall surface, where the bracket includes a securing piece, which has one end coupled to the wall surface; and a supporting piece, which is coupled to the wall surface, and which is configured to support the securing piece such that the securing piece is at an acute angle with the wall surface.

Here, the supporting piece may support the other end of the securing piece such that the other end of the securing piece is separated from the wall surface. A protrusion portion may be formed at the other end of the securing piece, where the supporting piece can be configured to support the securing piece by having the protrusion portion inserted into a holding indentation. A levelness adjustment screw may be coupled onto either side of the supporting piece, and the levelness adjustment screws may support the other end of the securing piece at either side.

The link portion can include a tilt portion, of which one end may be hinge-joined to the coupling piece, to enable the mass to tilt. Also, the link portion can include an arm portion, of which one end may be hinge-joined to the tilt portion, to enable the mass to swivel. In addition, the other end of the arm portion may be hingejoined to the bracket, to enable the mass to be extended from the wall surface.

Additional aspects and advantages of the present invention will be set forth in part in the description which follows, and in part will be obvious from the description, or may be learned by practice of the invention.

### BRIEF DESCRIPTION OF THE DRAWINGS

FIG. 1 is a perspective view illustrating a bracket according to an embodiment of the present invention.

FIG. 2 is a front view illustrating a securing piece according to an embodiment of the present invention.

FIG. 3 is a perspective view illustrating a supporting piece according to an embodiment of the present invention.

FIG. 4 is a side-elevational view illustrating a bracket according to an embodiment of the present invention.

FIG. 5 is a front view illustrating a bracket according to an embodiment of the present invention.

FIG. 6 is a perspective view illustrating a wall mount according to another embodiment of the present invention.

FIG. 7 is a side-elevational view illustrating a wall mount according to another embodiment of the present invention.

FIG. 8 is a front view illustrating a wall mount according to another embodiment of the present invention.

### DETAILED DESCRIPTION

The bracket and wall mount having the bracket, according to certain embodiments of the invention, will be described below in more detail with reference to the accompanying drawings. Those components that are the same or are in correspondence are rendered the same reference numeral regardless of the figure number, and redundant explanations are omitted.

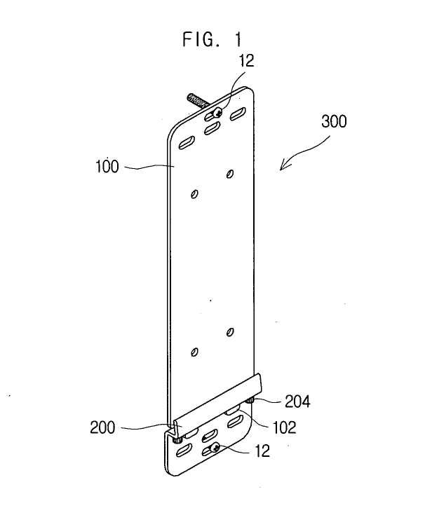

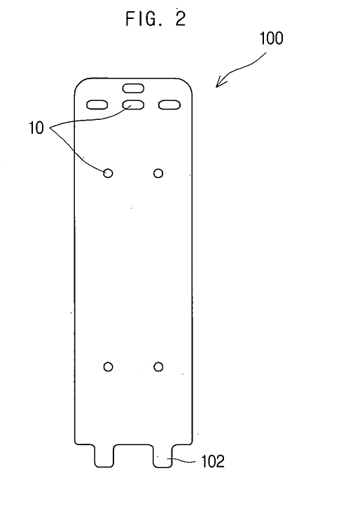

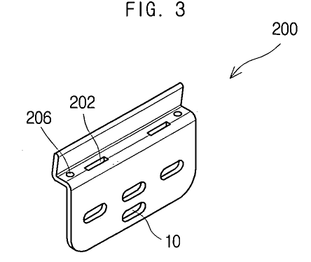

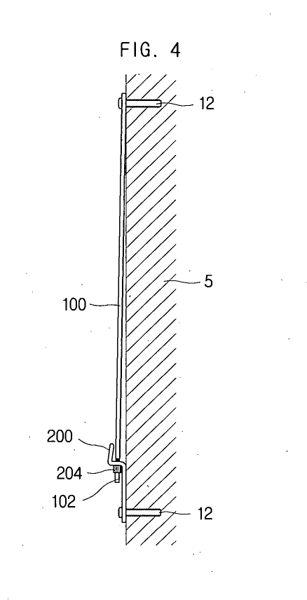

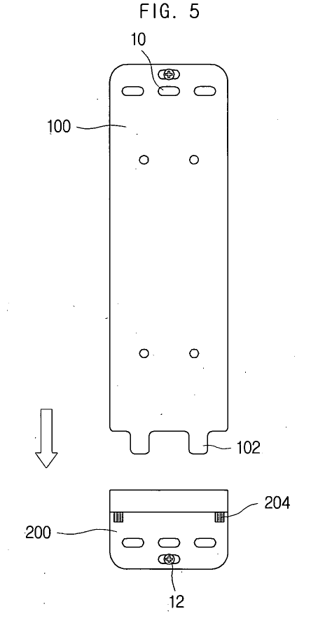

FIG. 1 is a perspective view illustrating a bracket according to an embodiment of the invention, FIG. 2 is a front view illustrating a securing piece according to an embodiment of the invention, and FIG. 3 is a perspective view illustrating a supporting piece according to an embodiment of the invention. Also, FIG. 4 is a side-elevational view illustrating a bracket according to an embodiment of the invention, and FIG. 5 is a front view illustrating a bracket according to an embodiment of the invention. In FIGS. 1 to 5, there are illustrated a wall surface 5, screw holes 10, securing screws 12, a securing piece 100, a protrusion portion 102, a supporting piece 200, holding indentations 202, levelness adjustment screws 204, levelness adjustment screw holes 206, and a bracket 300.

A bracket 300 according to this embodiment is an apparatus with which a mass may be secured to a wall surface 5. The bracket 300 may include a securing piece 100, of which one end may be coupled to the wall surface 5, and a supporting piece 200, which may be coupled to the wall surface 5, and which may support the securing piece 100 in a manner such that the securing piece 100 forms an acute angle with the wall surface 5. The bracket 300 may be easy to install, and may allow levelness adjustments even after its installation.

When mounting a mass onto a support, such as a wall surface 5, etc., the bracket 300 may serve as an apparatus that is secured first to the support. The mass can be, for example, a display 20, such as an LCD, PDP, etc.

The securing piece 100, as illustrated in FIGS. 1 and 2, may be coupled to the mass and may have one end coupled to the wall surface 5. In the one end of the securing piece 100, multiple screw holes 10 may be formed, through which securing screws 12 may be inserted. Screw holes 10 may also be formed in the body portion, located in the middle of the securing piece 100, which can be used in coupling the securing piece 100 to the mass.

The supporting piece 200, as illustrated in FIGS. 3 and 4, may be coupled to the wall surface 5 and may support the securing piece 100 in a manner that allows the securing piece 100 to form an acute angle with the wall surface 5. Here, the supporting piece 200 may support the other end of the securing piece 100 such that the other end is separated from the wall surface 5, thereby allowing the securing piece 100 to form an acute angle with the wall surface 5. A ledge may be formed at one end of the supporting piece 200 to support the other end of the securing piece 100 such that it is separated from the wall surface 5.

There may be cases in which the wall surface 5 to which a bracket is installed is not completely vertical or is slanting to one side. In such cases, securing a bracket onto the wall surface 5 can cause the coupled mass to droop. Also, if the mass coupled to the bracket is such that is implemented with a particular motion by a motor, the tolerances of the motion unit can increase the degree to which the mass droops.

Such problems can be resolved by using the bracket 300 based on this embodiment, to couple the mass to the wall surface 5 in an acute angle. This acute angle can be, for example, about 3°.

In the portion where the ledge is formed on the supporting piece 200, holding indentations 202 can be formed. The holding indentations 202 may be portions in which protrusion portions 102 may be inserted. The holding indentations 202 may hold the protrusion portions 102 to support the securing piece 100, so that the mass may be installed with greater ease. Multiple screw holes 10 can be formed in the portion where the supporting piece 200 comes into contact with the wall surface 5. Securing screws 12 may be inserted through the screw holes 10, to secure the supporting piece 200 to the wall surface 5. As illustrated in FIGS. 1 and 3, a levelness adjustment screw 204 can be coupled to each of the levelness adjustment screw holes 206 of the supporting piece 200, where the levelness adjustment screws 204 may support either side of the other end of the securing piece 100. If a mass is secured by the bracket 300 to the wall surface 5 for a lengthy period of time, the mass may slant to one side, making the mass unlevel. In such cases, the levelness adjustment screw 204 on the side at which slanting has occurred can be tightened or loosened, so that the levelness of the mass can be adjusted without having to reinstall the bracket 300.

As illustrated in FIGS. 2 and 5, protrusion portions 102 may be formed on the other end of the securing piece 100. The protrusion portions 102 can be inserted into the holding indentations 202 formed in the supporting piece 200, to be coupled with the supporting piece 200. In cases where the securing piece 100 is formed as an integrated part of the mass, the supporting piece 200 may first be coupled to the wall surface 5, and then the protrusion portions 102 of the securing piece 100 may be inserted into the holding indentations 202 to preliminarily secure the securing piece 100 onto the wall surface 5, after which the securing screws 12 may be inserted through the screw holes in the one end of the securing piece 100 to couple the securing piece 100 to the wall surface 5. Thus, by virtue of the bracket 300, a user may secure a mass coupled with the bracket 300 onto the wall surface 5 with a minimal amount of effort.

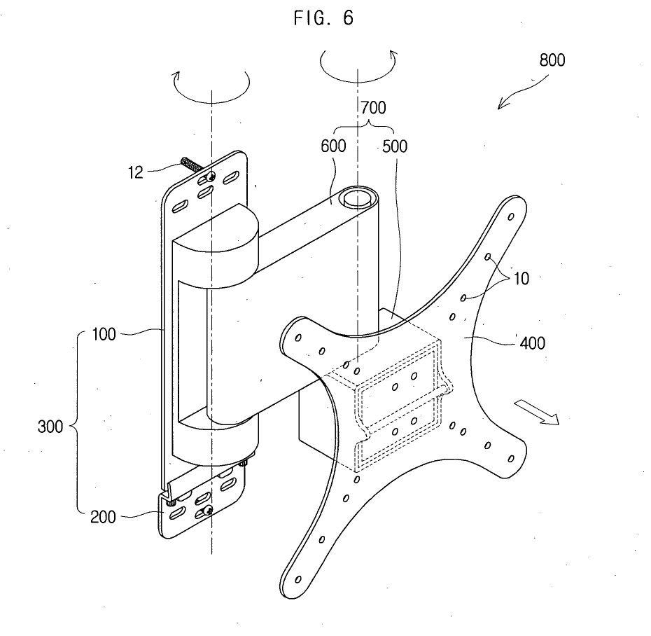

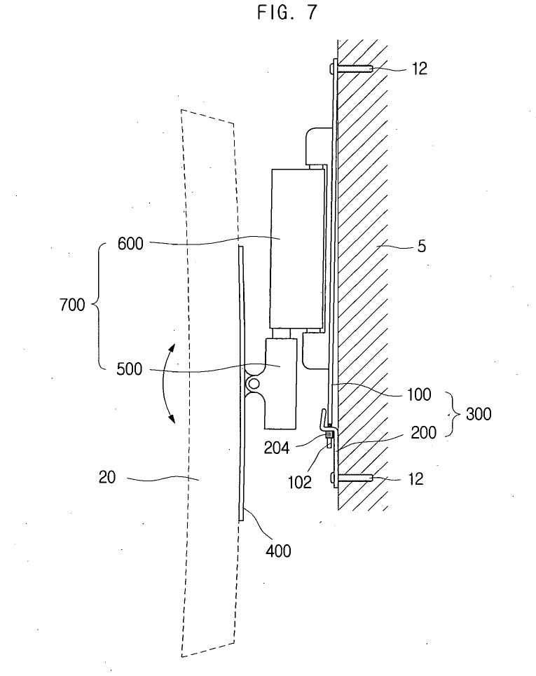

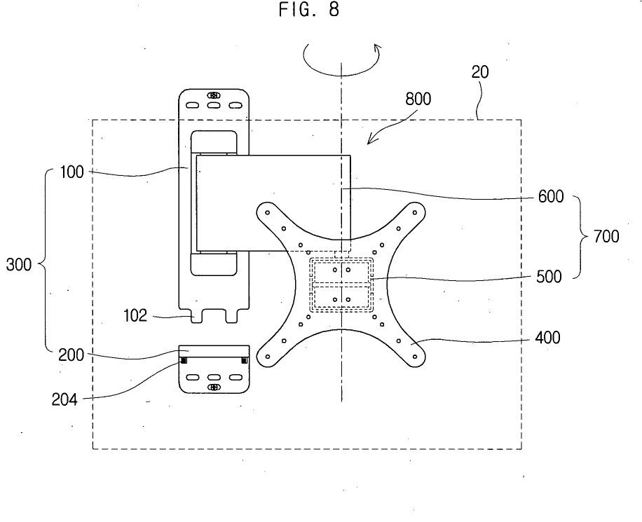

FIG. 6 is a perspective view illustrating a wall mount according to another embodiment of the invention, FIG. 7 is a side-elevational view illustrating a wall mount according to another embodiment of the invention, and FIG. 8 is a front view illustrating a wall mount according to another embodiment of the invention. In FIGS. 6 to 8, there are illustrated a display 20, a coupling piece 400, a tilt portion 500, an arm portion 600, a link portion 700, and a wall mount 800.

The wall mount 800 based on another embodiment of the invention is an apparatus for rotatably securing a mass to a wall surface 5. The wall mount 800 may include a coupling piece 400, which may be coupled to the mass, a link portion 700, one end of which may be coupled to the coupling piece 400, and a bracket 300, which may be coupled to the other end of the link portion 700 and coupled to the wall surface 5. The bracket 300 may include a securing piece 100, one end of which may be coupled to the wall surface 5, and a supporting piece 200, which may be coupled to the wall surface 5, and which may support the securing piece 100 in a manner such that the securing piece 100 forms an acute angle with the wall surface 5. The wall mount 800 may be easy to install, and may allow levelness adjustments even after its installation.

The wall mount 800 can be an apparatus for attaching or securing a mass, such as a display 20, to a support, such as a wall surfaces. In addition, the wall mount 800 can be an apparatus that is capable of implementing a mass secured to a wall surface 5 with rotating actions, such as swiveling and tilting, and extending actions, such as extending from the wall surface 5, etc.

A coupling piece 400, as illustrated in FIG. 6, may be the portion that couples the mass with the wall mount 800. Screw holes 10 can be formed in the coupling piece 400, so that the coupling piece 400 may be coupled to the mass with securing screws 12. A hinge can be formed on the rear of the coupling piece 400, so that the coupling piece 400 may be hinge-joined to the link portion 700.

The link portion 700 refers to a structure that can include one or more arms coupled to one another to allow relative movement. According to the coupling relationships of the arms, the link portion 700 may implement actions such as swiveling, tilting, and extending, etc. The link portion 700 of this particular embodiment can have one end coupled to the coupling piece 400.

As illustrated in FIG. 7, the link portion 700 may include a tilt portion 500, of which one end can be hinge-joined to the coupling piece 400, to enable a tilting motion for the mass, e.g. display 20. The tilt portion 500 may be hinge-joined to a hinge formed on the rear of the coupling piece 400, to enable a tilting action. According to whether or not a driving apparatus is coupled on for driving the display 20, the tilt portion 500 may be operated automatically or manually.

When the display 20 is operated automatically or manually, backlash may occur, due to the hinge-joints or tolerances of the driving apparatus, etc. However, in the- wall mount 800 based on this particular embodiment, the bracket 300 which supports the mass in an acute angle with the wall surface 5 may minimize the backlash. Moreover, since the bracket 300 is at an acute angle with the wall surface 5, the display 20 can be prevented from drooping forward due to the weight of the display 20.

As illustrated in FIG. 8, the link portion 700 may include an arm portion 600 that has one end hinge-joined to the tilt portion 500 to enable the display 20 to swivel. The one end of the arm portion 600 can be hinge-joined to the other end of the tilt portion 500 in a manner that allows the tilt portion 500 to rotate. Because the arm portion 600 may be coupled to the other end of the tilt portion 500 such that a swiveling action is enabled for the tilt portion 500, the display 20 may also perform a swiveling motion of rotating left and right. According to whether or not a driving apparatus is coupled on for swiveling the tilt portion 500, the arm portion 600 may be operated automatically or manually.

As described above, the wall mount 800 can be made capable of tilting motions, due to the coupling relationship between the coupling piece 400 and the tilt portion 500, and can be made capable of swiveling motions, due to the coupling relationship between the tilt portion 500 and the arm portion 600.

As illustrated in FIG. 6, the other end of the arm portion 600 can be hinge-joined with the bracket 300 to enable the display 20 to extend outwards from the wall surface 5. In this embodiment, the arm portion 600 may have one end hinge-joined to the tilt portion 500 in a manner that enables swiveling, and may have the other end hinge-joined to the bracket 300. Therefore, if rotating movements are performed simultaneously at both hinge-joint portions of the one end and the other end of the arm portion 600, an action may be implemented by which the display 20 may extend from the wall surface 5 to which the bracket 300 is secured. For the hinge-joint between the other end of the arm portion 600 and the bracket 300 also, according to whether or not a driving apparatus is coupled on, the extending action may be performed automatically or manually.

The bracket 300 may be coupled to the other end of the link portion 700, that is, the other end of the arm portion 600. The bracket 300 may include a securing piece 100, which may be coupled to the other end of the link portion 700 and which may have one end coupled to the wall surface 5, and a supporting piece 200, which may support the securing piece 100 to form an acute angle with the wall surface 5.

As illustrated in FIGS. 6 and 7, a securing piece 100 may be hinge-joined to the other end of the arm portion 600. One end of the securing piece 100 may be secured to the wall surface 5 by way of securing screws 12. The securing piece 100 may thus have one end secured to the wall surface 5 and the other end supported with a distance to the wall surface 5, such that the securing piece 100 may be secured forming an acute angle with the wall surface 5.

The supporting piece 200 may be coupled to the wall surface 5 and may support the securing piece 100 such that the other end of the securing piece 100 is separated from the wall surface 5, and as a result, the securing piece 100 may be supported in a position that forms an acute angle with the wall surface 5. By having the bracket 300 secure the display 20 device to form an acute angle with the wall surface 5, the problem of the display 20 drooping can be prevented, in cases where the wall surface 5 is not completely vertical. Here, the acute angle can be about 3°, for example.

In the portion where the ledge is formed on the supporting piece 200, holding indentations 202 can be formed. The holding indentations 202 may be portions in which protrusion portions 102 may be inserted. The holding indentations 202 may hold the protrusion portions 102 to support the securing piece 100, so that the display 20 may be installed with greater ease. Even in cases where the display 20 and the wall mount 800 are coupled together, the user may first couple the supporting piece 200 to the wall surface 5, insert the protrusion portions 102 of the securing piece 100 into the holding indentations 202 of the supporting piece 200, and then, after preliminarily securing the display 20, may secure one end of the securing piece 100 using securing screws 12.

As illustrated in FIG. 6, levelness adjustment screws 204 can be coupled to the levelness adjustment screw holes 206 in both sides of the supporting piece 200, where the levelness adjustment screws 204 may support both sides of the other end of the securing piece 100. If a display 20 is secured by the bracket 300 to the wall surface 5 for a lengthy amount of time, the display 20 may slant to one side, making the mass unlevel. In such cases, the levelness adjustment screw 204 on the side at which slanting has occurred can be tightened or loosened, so that the levelness of the display 20 may be adjusted without having to reinstall the bracket 300.

As described above, the bracket 300 in this embodiment can be substantially the same in composition and function as the bracket 300 according to the previously described embodiment.

According to certain aspects of the invention as set forth above, for securing a mass to a wall surface using a wall mount, a bracket and a wall mount are provided which allow easy installation and which allow levelness adjustments even after installation.

While the spirit of the invention has been described in detail with reference to particular embodiments, the embodiments are for illustrative purposes only and do not limit the invention. It is to be appreciated that those skilled in the art can change or modify the embodiments without departing from the scope and spirit of the invention.

What is claimed is:

1. A bracket for securing a mass to a wall surface, the bracket comprising:
a securing piece coupled to the mass and having one end thereof coupled to the wall surface, and
a supporting piece coupled to the wall surface and configured to support the securing piece such that the securing piece is at an acute angle with the wall surface.

2. The bracket of claim 1, wherein the supporting piece supports the other end of the securing piece such that the other end of the securing piece is separated from the wall surface.

3. The bracket of claim 1, wherein a protrusion portion is formed at the other end of the securing piece,
and the supporting piece is configured to support the securing piece by having the protrusion portion inserted into a holding indentation.

4. The bracket of claim 1, wherein a levelness adjustment screw is coupled to either side of the supporting piece,
and the levelness adjustment screw is configured to support either side of the other end of the securing piece.

5. A wall mount for rotatably securing a mass to a wall surface, the wall mount comprising:
a coupling piece coupled to the mass;
a link portion having one end thereof coupled to the coupling piece; and
a bracket coupled to the other end of the link portion and coupled to the wall surface, the bracket comprising:
a securing piece having one end thereof coupled to the wall surface; and
a supporting piece coupled to the wall surface and configured to support the securing piece such that the securing piece is at an acute angle with the wall surface.

6. The wall mount of claim 5, wherein the supporting piece is configured to support the other end of the securing piece such that the other end of the securing piece is separated from the wall surface.

7. The wall mount of claim 5, wherein a protrusion portion is formed at the other end of the securing piece,
and the supporting piece is configured to support the securing piece by having the protrusion portion inserted into a holding indentation.

8. The wall mount of claim 5, wherein a levelness adjustment screw is coupled to either side of the supporting piece,
and the levelness adjustment screw is configured to support either side of the other end of the securing piece.

9. The wall mount of claim 5, wherein the link portion comprises:
a tilt portion having one end thereof hingejoined to the coupling piece such that the mass is capable of tilting.

10. The wall mount of claim 9, wherein the link portion comprises:
an arm portion having one end thereof hinge-joined to the tilt portion such that the mass is capable of swiveling.

11. The wall mount of claim 10, wherein the other end of the arm portion is hinge-joined to the bracket such that the mass is capable of extending from the wall surface.
